(19) United States
(12) Patent Application Publication
(10) Pub. No.: US 2026/0187118 A1
(43) Pub. Date: Jul. 2, 2026

(54) Liaising Multi-Information and Actions Around Contextually Specific Requests

(71) Applicant: Google LLC, Mountain View, CA (US)

(72) Inventors: Karan Gupta, New Delhi (IN); Akanksha Joshi, Bengaluru (IN); Raviteja Govindaraju, Hyderabad (IN); Ramprasad Sedouram, BANGALORE (IN); Karthik Srinivas, Bengaluru (IN); Mutum Bindiyarani Devi, Bengaluru (IN); Rahul Mullick, Bengaluru (IN); Puneetha Pai B P, Bengaluru (IN)

(73) Assignee: Google LLC, Mountain View, CA (US)

(21) Appl. No.: 19/006,051

(22) Filed: Dec. 30, 2024

(51) Int. Cl. G06F 16/3332; G06F 16/338; G06F 16/383

(52) U.S. Cl. CPC G06F 16/3334; G06F 16/338; G06F 16/383

(57) ABSTRACT

A method for providing personalized responses to queries using a personalized large language model (LLM) includes receiving a query from a user specifying a task for an assistant LLM to perform, the query captured by an assistant-enabled device associated with the user, and processing the query to identify, from a datastore of a plurality of embedding chunks each previously stored in the datastore by the assistant LLM, a particular embedding chunk that is relevant to the query. The method also includes generating an on-the-fly prompt by stitching the particular embedding chunk and the query together, and processing, by the assistant LLM, the on-the-fly prompt to generate a personalized response to the query.

### TECHNICAL FIELD

This disclosure relates to liaising multi-information and actions around contextually specific requests.

### BACKGROUND

Large language models (LLMs) that generate text in response to a user input are becoming increasingly popular as generative artificial intelligence (AI) grows in popularity. Certain LLMs are trained to provide generic template responses, however these responses fall short of incorporating context of the user, and instead provide the same output to all users. While including context into an LLM prompt may assist in generating more personalized responses, incorporating lengthy context that may or may not be relevant to a particular prompt into an LLM is computationally inefficient during inference.

### SUMMARY

One aspect of the disclosure provides a computer-implemented method that when executed on data processing hardware causes the data processing hardware to perform operations that include receiving a query from a user specifying a task for an assistant large language model (LLM) to perform. Here, the query is captured by an assistant-enabled device associated with the user. The operations also include processing the query to identify, from a datastore of a plurality of embedding chunks each previously stored in the datastore by the assistant LLM, a particular embedding chunk that is relevant to the query. The operations further include generating an on-the-fly prompt by stitching the particular embedding chunk and the query together, and processing, by the assistant LLM, the on-the-fly prompt to generate a personalized response to the query.

Implementations of the disclosure may include one or more of the following optional features. In some implementations, the task specified by the query includes a retrieval request for the assistant LLM to retrieve one or more documents stored in a personal repository associated with the user. In some examples, the plurality of embedding chunks are stored in the datastore during an indexing process by obtaining a plurality of documents stored in a personal repository associated with the user, and assigning each document of the plurality of documents into one or more document chunks. For each corresponding document chunk of the one or more document chunks, these examples also include processing the corresponding document chunk to extract, from the corresponding document chunk, metadata associated with each of the documents assigned to the corresponding document chunk, encode the respective metadata extracted from the corresponding document chunk and the documents assigned to the corresponding document chunk to generate a corresponding embedding chunk. Here, the indexing process also includes storing the embedding chunks in the datastore. In these examples, processing the on-the-fly prompt to generate the personalized response to the query may include querying, using the on-the-fly prompt, the particular embedding chunk stored in the datastore to identify, from the documents assigned to the document chunk associated with the particular embedding chunk, one or more documents relevant to the query, and summarizing the one or more documents identified as being relevant to the query to generate a summary of relevant documents. Additionally or alternatively, the operations further include displaying, in a graphical user interface (GUI) displayed on a screen in communication with the assistant-enabled device associated with the user, the personalized response to the query. Here, displaying the personalized response to the query may include at least one of displaying, in the GUI, a graphical element representing a ranked list of the one or more documents identified as being relevant to the query, and superimposing, in the GUI, a graphical indicator highlighting a sequence of characters displayed in the GUI at a first location, the sequence of characters corresponding to the extracted metadata associated with the one or more documents identified as being relevant to the query.

In some implementations, receiving the query from the user includes one or more of receiving audio data corresponding to the query, the audio data spoken by the user and captured by the assistant-enabled device, receiving, in a graphical user interface (GUI) displayed on a screen in communication with the assistant-enabled device, a user input indication indicating a spatial input applied at a first location in the GUI, and receiving a textual representation of the prompt. In these implementations, the operations may further include detecting a trigger event, and in response to detecting the trigger event, activating the GUI displayed on the screen to enable detection of spatial inputs, and a speech recognition model to enable the performance of speech recognition on incoming audio data captured by the assistant-enabled device. Here, detecting the trigger event may include one of receiving, in the GUI displayed on the screen, a user input indication indicating selection of a graphical element, receiving a user input indication indicating selection of a physical button disposed on the assistant-enabled device, detecting a predefined gesture performed by the user, or detecting a predefined movement/pose of the assistant-enabled device. In some examples, the operations further include receiving local context associated with the query, and concatenating the on-the-fly prompt with the local context. Here, processing the on-the-fly prompt to generate the personalized response to the query includes processing, by the assistant LLM, the on-the-fly prompt concatenated with the local context to generate the personalized response to the query.

Another aspect of the disclosure provides a system including data processing hardware and memory hardware in communication with the data processing hardware. The memory hardware stores instructions that when executed by the data processing hardware cause the data processing hardware to perform operations that include receiving a query from a user specifying a task for an assistant large language model (LLM) to perform. Here, the query is captured by an assistant-enabled device associated with the user. The operations also include processing the query to identify, from a datastore of a plurality of embedding chunks each previously stored in the datastore by the assistant LLM, a particular embedding chunk that is relevant to the query. The operations further include generating an on-the-fly prompt by stitching the particular embedding chunk and the query together, and processing, by the assistant LLM, the on-the-fly prompt to generate a personalized response to the query.

This aspect may include one or more of the following optional features. In some implementations, the task specified by the query includes a retrieval request for the assistant LLM to retrieve one or more documents stored in a personal repository associated with the user. In some examples, the plurality of embedding chunks are stored in the datastore during an indexing process by obtaining a plurality of documents stored in a personal repository associated with the user, and assigning each document of the plurality of documents into one or more document chunks. For each corresponding document chunk of the one or more document chunks, these examples also include processing the corresponding document chunk to extract, from the corresponding document chunk, metadata associated with each of the documents assigned to the corresponding document chunk, encode the respective metadata extracted from the corresponding document chunk and the documents assigned to the corresponding document chunk to generate a corresponding embedding chunk. Here, the indexing process also includes storing the embedding chunks in the datastore. In these examples, processing the on-the-fly prompt to generate the personalized response to the query may include querying, using the on-the-fly prompt, the particular embedding chunk stored in the datastore to identify, from the documents assigned to the document chunk associated with the particular embedding chunk, one or more documents relevant to the query, and summarizing the one or more documents identified as being relevant to the query to generate a summary of relevant documents. Additionally or alternatively, the operations further include displaying, in a graphical user interface (GUI) displayed on a screen in communication with the assistant-enabled device associated with the user, the personalized response to the query. Here, displaying the personalized response to the query may include at least one of displaying, in the GUI, a graphical element representing a ranked list of the one or more documents identified as being relevant to the query, and superimposing, in the GUI, a graphical indicator highlighting a sequence of characters displayed in the GUI at a first location, the sequence of characters corresponding to the extracted metadata associated with the one or more documents identified as being relevant to the query.

In some implementations, receiving the query from the user includes one or more of receiving audio data corresponding to the query, the audio data spoken by the user and captured by the assistant-enabled device, receiving, in a graphical user interface (GUI) displayed on a screen in communication with the assistant-enabled device, a user input indication indicating a spatial input applied at a first location in the GUI, and receiving a textual representation of the prompt. In these implementations, the operations may further include detecting a trigger event, and in response to detecting the trigger event, activating the GUI displayed on the screen to enable detection of spatial inputs, and a speech recognition model to enable the performance of speech recognition on incoming audio data captured by the assistant-enabled device. Here, detecting the trigger event may include one of receiving, in the GUI displayed on the screen, a user input indication indicating selection of a graphical element, receiving a user input indication indicating selection of a physical button disposed on the assistant-enabled device, detecting a predefined gesture performed by the user, or detecting a predefined movement/pose of the assistant-enabled device. In some examples, the operations further include receiving local context associated with the query, and concatenating the on-the-fly prompt with the local context. Here, processing the on-the-fly prompt to generate the personalized response to the query includes processing, by the assistant LLM, the on-the-fly prompt concatenated with the local context to generate the personalized response to the query.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A and 1B are schematic views of example environments using a personalized large language model (LLM) system.

FIG. 2 is a schematic view of example components of the LLM system.

FIG. 3 is a schematic view of an example indexing process for generating embedding chunks based on a personal repository of a user.

FIGS. 4A-4D are example graphical user interfaces (GUIs) rendered on a screen of a user device including the personalized LLM system.

FIG. 5 is a flowchart of an example arrangement of operations for a method of providing personalized responses to textual prompts using the LLM system.

FIG. 6 is a schematic view of an example computing device that may be used to implement the systems and methods described herein.

Like reference symbols in the various drawings indicate like elements.

### DETAILED DESCRIPTION

Large language models (LLMs) that generate text in response to a user input are becoming increasingly popular as generative artificial intelligence (AI) grows in popularity. Certain LLMs are trained to provide generic template responses, however these responses fall short of incorporating personal information related to the user, and instead provide the same output to all users. While incorporating context such as personal information into an LLM prompt may assist in generating more personalized responses to users, digital and physical documents of users may be distributed across multiple platforms and/or storage locations, making tracking and retrieval by an LLM when executing a task computationally inefficient during inference.

Given the role that LLMs play in authorship of content, corporate and personal communication, pieces of written content, and synthesis of information from sources with varying degrees of relevance, the ability of the LLM to process documents from disparate locations and produce unique/tailored responses that address the context of the user is critical for developing generative AI systems that support particular audiences, creators, and information needs. By including LLMs that take into account the personal (and other) context in which the LLM is expected to be used, the LLM can provide personalized responses to user inputs that address multiple personalized information needs for the user, rather than a standard/generic template response.

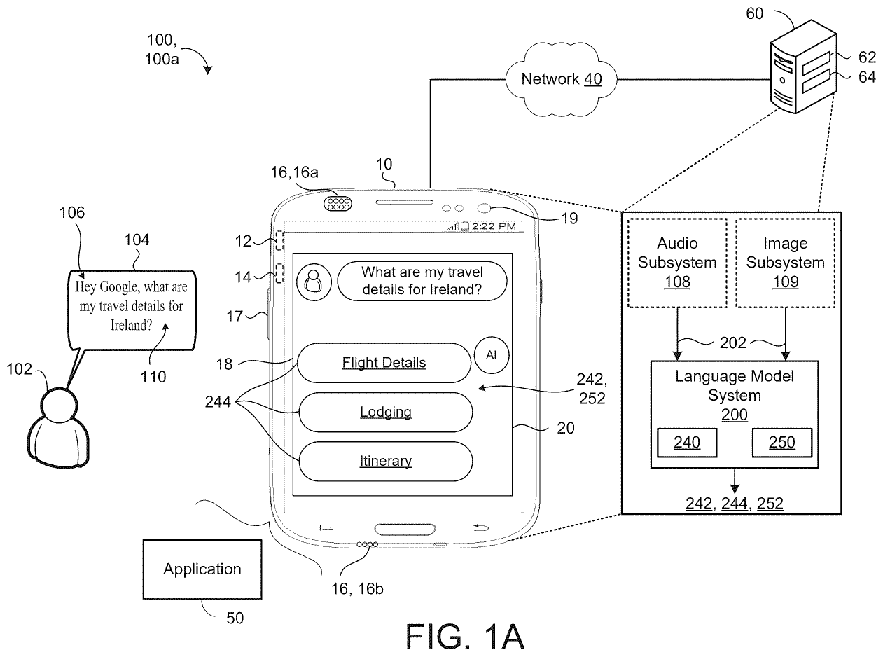

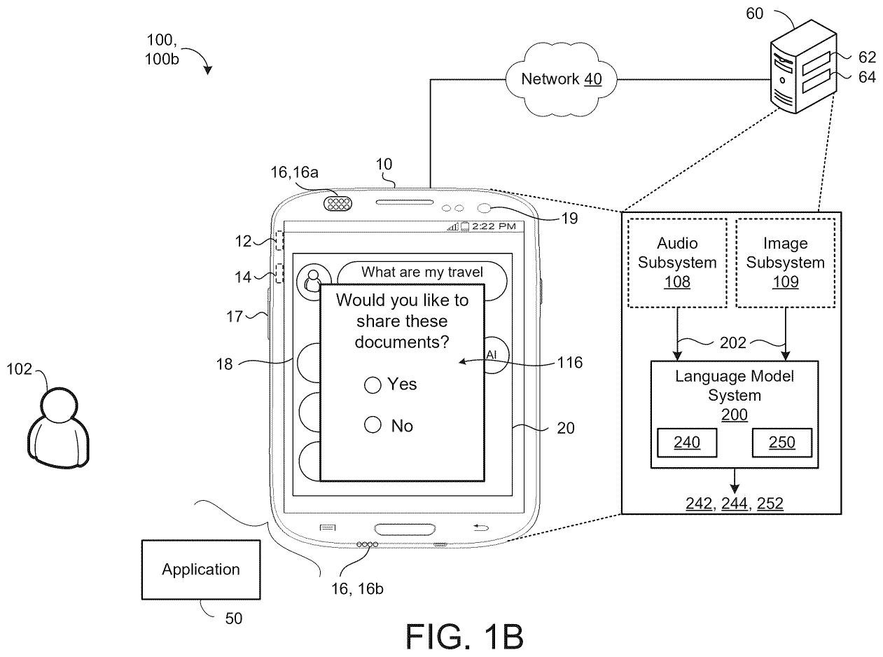

FIGS. 1A and 1B are example systems 100a, 100b each including a user device 10 and/or a remote system 60 in communication with the user device 10 via a network 40. The user device 10 and/or the remote system 60 executes a language model system 200 that a user 102 may interact with through speech, textual inputs, image inputs, and/or spatial inputs such that the language model system 200 is capable of generating personalized responses to queries 202 specifying a task for a personalized assistant large langue model (LLM) 240 (also referred to as an assistant LLM 240) of the language model system 200 to perform.

In the example shown, the user device 10 corresponds to a smart phone, however the user device 10 can include other computing devices having, or in communication with, display screens, such as, without limitation, a tablet, smart display, desktop/laptop, smart watch, smart appliance, smart glasses/headset, or vehicle infotainment device. The user device 10 includes data processing hardware 12 and memory hardware 14 storing instructions that when executed on the data processing hardware 12 cause the data processing hardware 12 to perform operations. The remote system 60 (e.g., server, cloud computing environment) also includes data processing hardware 62 and memory hardware 64 storing instructions that when executed on the data processing hardware 62 cause the data processing hardware 62 to perform operations. As described in greater detail below, the language model system 200 executing on the user device 10 and/or the remote system 60 includes the LLM 240 and a response generator 250 and has access to a data store 230 stored on the memory hardware 14, 64. In some examples, execution of the language model system 200 is shared across the user device 10 and the remote system 60.

The user device 10 further includes an audio system 16 with an audio capture device (e.g., microphone) 16, 16a for capturing and converting spoken utterances 104 within the environment into electrical signals and a speech output device (e.g., a speaker) 16, 16b for communicating an audible audio signal (e.g., as output audio data from the device 10). While the user device 10 implements a single audio capture device 16a in the example shown, the user device 10 may implement an array of audio capture devices 16a without departing from the scope of the present disclosure, whereby one or more capture devices 16a in the array may not physically reside on the user device 10, but be in communication with the audio system 16. The user device 10 also includes an image capture device (e.g., camera) 19 for capturing and converting images within the environment. The user device 10 may also include a physical button 17 disposed on the user device 10 and configured to receive a tactile selection by a user 102 for invoking the language model system 200. The user device 10 also executes, for display on a screen 18 in communication with the data processing hardware 12, a graphical user interface (GUI) 20 configured to capture user input indications via any one of touch, gesture, gaze, and/or an input device (e.g., mouse, trackpad, or stylist) for controlling functionality of the user device 10. The GUI 20 may be an interface associated with an assistant application 50 executing on the user device 10 that the user 102 interacts with.

The user device 10 may include an audio subsystem 108 for extracting audio data from an utterance 104 to generate the query 202. For instance, referring to FIG. 1A, the audio subsystem 108 may receive streaming audio captured by the one or more microphones 16a of the user device 10 that corresponds to an utterance 104 spoken by the user 102 and extract the audio data. The audio data may include acoustic features such as Mel-frequency cepstrum coefficients (MFCCs) or filter bank energies computed over windows of an audio signal. Thereafter, the audio subsystem 108 employs a speech recognizer to convert the audio data into a corresponding transcription of the spoken utterance 104. In the example shown, the utterance 104 spoken by the user 102 is converted into a transcription characterizing a textual prompt 102 that includes “Hey Google, what are my travel details for Ireland?” In some implementations, rather than issuing a spoken prompt that is converted into the textual prompt 202, the user 102 submits the textual prompt 202 directly by typing the text (e.g., via an external keyboard in communication with the user device 10 or a graphical element corresponding to a graphical keyboard displayed on in the GUI 20 of the user device 10). Additionally, the user device 10 includes an image subsystem 109 for extracting image data (e.g., pixels) from images capturing the environment of the user 102 to generate the query 202. For example, the user 102 may input an image (i.e., via the image capture device 19) of one or more objects in the environment of the user 102. The image subsystem 109 may extract the image data to generate the query 202 for the language model system 200. In some examples, a single query 202 concatenates image data extracted by the image subsystem 109 from an image input by the user 102 and a textual prompt (either derived from a spoken utterance by the audio subsystem 108 or input directly via the physical/virtual keyboard).

The user device 10 may execute (i.e., on the data processing hardware 12) a hotword detector (not shown) configured to detect a presence of a hotword 106 in streaming audio without performing semantic analysis or speech recognition processing on the streaming audio. The hotword detector may execute on the audio subsystem 108. The hotword detector may receive the audio data to determine whether the utterance 104 includes a particular hotword 106 (e.g., Hey Google) spoken by the user 102. That is, the hotword detector may be trained to detect the presence of the hotword 106 (e.g., Hey Google) or one or more other variants of the hotword (e.g., Ok Google) in the audio data. Detecting the presence of the hotword 106 in the audio data may correspond to a trigger event that invokes the assistant application 50 to activate the GUI 20 displayed on the screen 18 to enable the detection of spatial inputs, and activate a speech recognizer of the audio subsystem 108 to perform speech recognition on the audio data corresponding to the utterance 104 of the hotword 106 and/or one or more other terms characterizing the task 110 that follows the hotword 106. In some examples, the hotword 106 is spoken in the utterance 104 subsequent to the task 110 such the portion of the audio data characterizing the task 110 is buffered and retrieved by the speech recognizer upon detection of the hotword 106 in the audio data. In some implementations, the GUI 20 is activated when the user device 10 receives, in the GUI 20, a user input indication indicating a spatial input applied to a graphical element (e.g., a graphical microphone) displayed on the screen 18 of the GUI 20. In other implementations, the user device 10 receives a user input indication indicating selection of the physical button 17 disposed on the user device 10. In other implementations, the GUI 20 is activated when the user device 10 detects (e.g., via image and/or radar sensors) a predefined gesture performed by the user 102, or detecting a predefined movement/pose of the user device 10 (e.g., using one or more sensors such as an accelerometer and/or gyroscope). Thereafter, the audio subsystem 108 receives, as input, the audio data corresponding to the utterance 104, and generates/predicts, as output, the query 202 specifying the task 110 for the language model system 200 (i.e., the LLM 240) to perform.

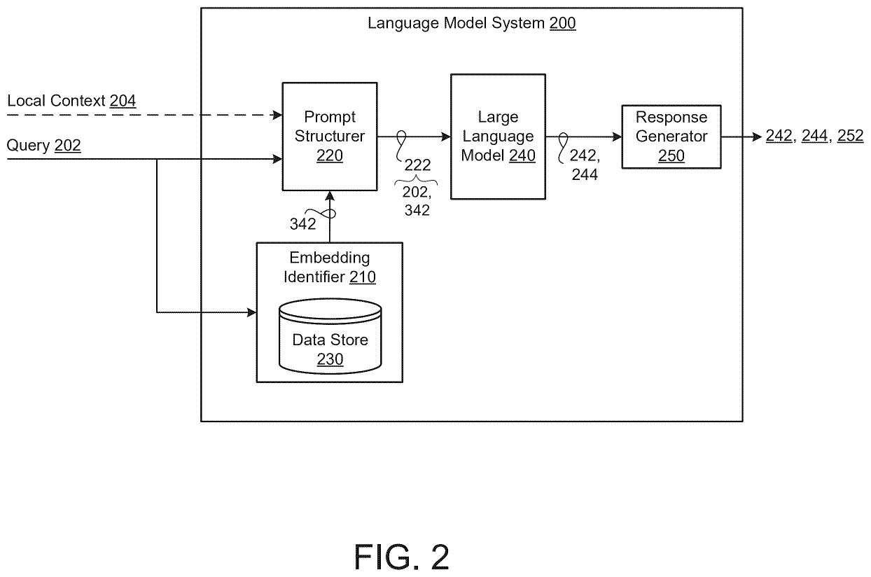

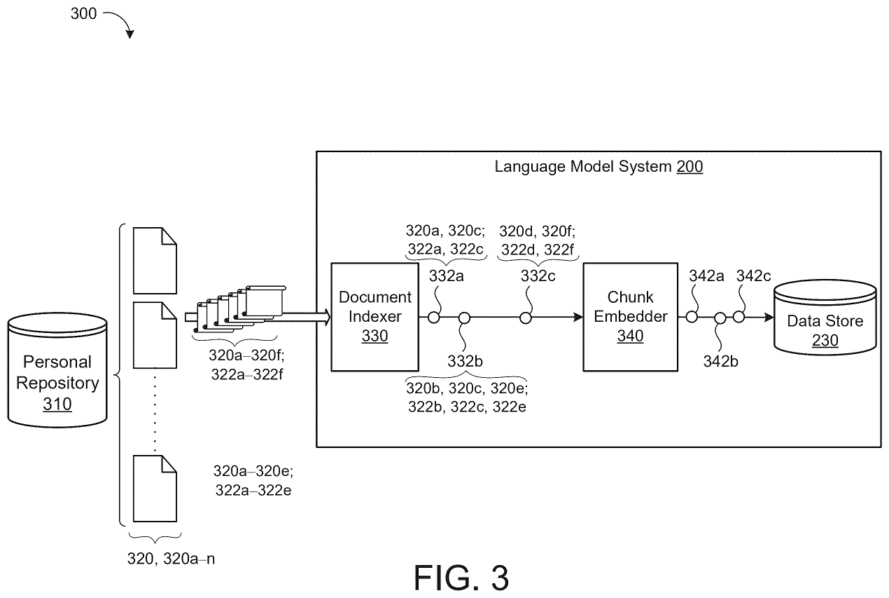

With continued reference to FIG. 1A and FIG. 2, the language model system 200 executes the LLM 240 that receives, as input, the query 202 and generates, as output, a personalized response 242 to the query 202. In the example shown, the utterance 104 includes the phrase, “what are my travel details for Ireland” that requires the LLM 240 to access a datastore containing personal data (i.e., travel details) of the user 102. In other words, the task 110 specified by the query 202 includes a retrieval request that requests the LLM 240 to retrieve one or more documents 320 (FIG. 3) stored in a personal repository 310 (FIG. 3) associated with the user 102. Notably, the personal repository 310 may include documents 320 stored across multiple platforms (e.g., cloud storage services, email platforms, enterprise content management systems, local file systems, physical locations (i.e., geotagged) etc.) associated with the user 102. Rather than, for each query 202, tasking the LLM 240 with accessing all locations of the documents 320 and searching each of the documents 320 stored in the personal repository 310 of the user 102, the language model system 200 leverages retrieval-augmented generation to provide the LLM 240 with the context to quickly and efficiently search the documents 320 associated with the user 102 to generate the personalized response 242 to the query 202.

Referring to FIG. 3, an indexing process 300 for pre-processing the personal data (e.g., documents 320) associated with the user 102 is shown. The LLM 240 may execute the indexing process 300 on the remote system 60 of FIGS. 1A and 1B. As shown, during the indexing process 300, the LLM 240 obtains a plurality of documents 320a-n stored in the personal repository 310 of the user 102. In some instances, before executing the indexing process 300, the language model system 200 may prompt the user 102 for authorization to access the plurality of documents 320 stored in the personal repository 310. By the same notion, the user 102 may revoke previously authorized access to the plurality of documents 320 stored in the personal repository 310 at any time. The personal repository 310 may reside on the memory hardware 14 of the user device 10 and/or the memory hardware 64 of the remote system 60.

The LLM 240 executes a document indexer 330 that receives, as input, the plurality of documents 320 and assigns each document 320 of the plurality of documents 320 into one or more document chunks 332. For instance, the document indexer 330 may leverage multiple document processing techniques (e.g., summarization, keyword extraction, and entity recognition) to extract metadata 322 associated with each document 320, and group the documents 320 into one or more document chunks 332 based on similarities in the content and/or metadata 322 of each document 320. In some implementations, each document chunk 332 has a distinct set of documents 320 assigned to it. In other implementations, one or more document chunks 332 each have one or more documents 320 in common. In other words, one or more documents 320 may be assigned to more than one document chunk 332.

For example, as shown in FIG. 3, the document indexer 330 receives the documents 320a-320f as input, and process the documents 320a-320f to index and assign each document 320a-320f to a respective document chunk 332a-c. In this example, the document indexer 330 may identify that the documents 320a, 320c and corresponding metadata 322a, 322c are associated with travel of the user 102, and assign the documents 320a, 320c and corresponding metadata 322a, 322c to a first document chunk 332a. Similarly, the document indexer 330 may identify that the documents 320b, 320c, 320e and the corresponding metadata 322b, 322c, 322e are associated with tax documents of the user 102 and assign the documents 320b, 320c, 320e and corresponding metadata 322b, 322c, 322e to a second document chunk 332b. Finally, the document indexer 330 may identify that the documents 320d, 320f and corresponding metadata 322d, 322f are associated with medical records of the user 102, and assign the documents 320d, 320f and corresponding metadata 322d, 322f to third document chunk 332c.

The LLM 240 also executes a chunk embedder 340 that receives each of the document chunks 332 as input and, for each corresponding document chunk 332, encodes the corresponding document chunk 332 to generate a corresponding embedding chunk 342. Here, the chunk embedder 340 may encode the respective metadata 322 extracted from the documents 320 assigned to the document chunk 332 as well as the documents 320 themselves. Thereafter, the LLM 240 stores the encoded embedding chunks 342 in the datastore 230. To ensure that the LLM 240 has access to fresh information, the language model system 200 may periodically execute the indexing process 300 to ensure that the datastore 230 of embedding chunks 342 of the documents 320 contains the most up to date/relevant documents 320 in the personal repository 310 associated with the user 102.

Referring back to FIG. 2, the language model system 200 further includes an embedding identifier 210, a prompt structurer 220, and a response generator 250. The embedding identifier 210 includes the datastore 230 storing the plurality of embedding chunks 342a-n each previously stored in the datastore 230 by the LLM 240 during the indexing process 300. The embedding identifier 210 is configured to receive the query 202 submitted by the user 102 as input and process the query 202 to identify, from the datastore 230 of embedding chunks 342, a particular embedding chunk 342 that is relevant to the query 202 as output. For instance, the embedding identifier 210 may perform a vector similarity search between the query 202 and the embedding chunks 342 to identify the most relevant embedding chunk 342 and its assigned documents 320 for the LLM 240 to retrieve and/or search to answer the query 202.

Thereafter, the prompt structurer 220 receives the query 202 and the particular embedding chunk 342, and generates, as output, an on-the-fly prompt 222 by stitching the particular embedding chunk 342 and the query 202 together. Here, the on-the-fly prompt 222 may guide the LLM 240 to only process the one or more documents 320 that are assigned to the particular embedding chunk 342, thereby narrowing the number of documents 320 that the LLM 240 needs to retrieve to accomplish the task 110 specified by the query 202. The LLM 240 receives the on-the-fly prompt 222 and processes the on-the-fly prompt 222 to generate the personalized response to the query 242. In some instances, the LLM 240 processes the on-the-fly prompt 222 by querying, using the on-the-fly prompt 222, the particular embedding chunk 342 to identify, from the documents 320 assigned to the document chunk 332 associated with the particular embedding chunk 342, one or more documents 320 that are relevant to the query 202. The LLM 240 may further summarize the identified one or more documents 320 to generate a summary of relevant documents 244.

Referring again to the example shown in FIG. 1A, the embedding identifier 210 may identify a particular embedding chunk 342 including all travel documents 320 of the user 102 as similar to the query 202 “what are my travel details for Ireland” and serve the embedding chunk 342 including the travel documents 320 stitched to the query 202 to the LLM 240 for processing the on-the-fly prompt 222. The LLM 240 thereafter queries the particular embedding chunk 342 to identify which of the one or more documents 320 are relevant (i.e., are associated with an upcoming trip to Ireland) to the query 202 to provide the personalized response 242. The LLM 240 may further summarize the corresponding metadata 322 of each identified relevant document 320 to generate the summary of relevant documents 244. Here, the summary of the relevant documents 244 may group the identified relevant documents 320 to help the user 102 quickly navigate the personalized response 242.

As shown, when the LLM 240 generates the personalized response 242 to the query 202, the response generator 250 may generate/provide the personalized response 242 and/or the summary of relevant documents 244 to the query 202 as a textual representation 252. Here, the user device 10 displays the personalized response 242 in the GUI 20 for the user 102 to review. In the example shown, the response generator 250 generates the textual representation 252 of the personalized response 242 including the summary of relevant documents 244 in the form of categories (i.e., “flight details,” “lodging,” and “itinerary”) that the LLM 240 retrieved in response to the query 202. As shown, the summary of relevant documents 244 may include hyperlinks to view the particular category of documents 320 for display in the GUI 20. In some examples, the response generator 250 employs a text-to-speech (TTS) system (not shown) to convert the textual representation 252 of the personalized response 242 into synthesized speech. In these examples, the response generator 250 generates the synthesized speech for audible output from the speaker 16b of the user device 10 in addition to, or in lieu of, displaying the textual representation 252 of the personalized response 242 in the GUI 20.

In some implementations, the response generator 250 further modifies the personalized response 242 to direct the user 102 to the most relevant documents 320 identified by the LLM 240. For instance, the personalized response 242 may include a ranked list of the one or more documents 320 identified as relevant to the query 202. Here the response generator 250 may display, in the GUI 20, a graphical element representing the ranked list of the one or more documents 320 identified as relevant to the query 202. Additionally or alternatively, the response generator 250 may visually underline, highlight, overlay, or modify the graphical elements representing the one or more documents 320 identified as relevant to the query 202. In some instances, the response generator 250 may apply color gradations signifying the availability and/or security level (i.e., password protected) of each of the documents 320. As an example, documents 320 that are available may be rendered in GUI 20 as green graphical elements, while documents that are password protected and/or are not available may be rendered in the GUI 20 as red graphical elements. In implementations where the relevant documents 320 are embodied in physical copies, the response generator 250 may generate the personal response as a three-dimensional (3D) augmented reality element identifying the particular locations (e.g., geotagged locations) of the relevant documents 320.

Referring to FIG. 1B, in some implementations, the language model system 200 may prompt the user 102 with a next action for the personalized response 242. In the example shown, the user device 10 renders/displays a graphical element 116 representing a notification to the user 102 that asks “Would you like to share these documents?” and includes graphical elements for the user 102 to select “Yes” or “No” to instruct the language model system 200 (e.g., via the assistant application 50) to share the personalized response 242 with another party (e.g., a travel companion).

Referring again to FIGS. 1B and 2, in some implementations, the LLM 240 receives local context 204 associated with the query 202 and/or the user 102 in addition to receiving the query 202. Here, the LLM 240 augments the on-the-fly prompt 222 by concatenating the on-the-fly prompt 222 with the local context 204 where processing the on-the-fly prompt 222 to generate the personalized response 242 to the query 202 includes processing, by the LLM 240, the on-the-fly prompt 222 concatenated with the local context 204 to generate the personalized response 242. Here, the local context 204 may be concatenated in plain text with the query 202 and the user prompt embedding 212.

The local context 204 may include any previous tasks or queries input to the LLM 240 and may include at least one of a recent activity history including previous queries during the current dialog session and/or previous dialog sessions between the user 102 and the LLM 240, geographical location data, and/or site visits by the user 102, recent documents from the personal repository 310 of the user 102 that have yet to be processed by the indexing process 300, or recent user history information associated with the query 202. For example, the user 102 may interact with a personal assistant (e.g., assistant 50) of the user device 10 that uses the LLM 240. In this example, the local context 204 may indicate previous tasks/queries as well as previous responses from the LLM 240.

In some instances, the language model system 200 receives the local context 204 in lieu of the query 202, and generates the personalized response 242 based solely on the local context 204. As an example, the local context 204 may include geographical location data of the user 102 indicating that the user 102 is at the airport. Based on this local context 204, the language model 200 may automatically (i.e., without input from the user 102) generate a personalized response 242 for the user 102 based on the location of the user 102. Here, the personalized response 242 may ask the user 102 if the user 102 would like to view boarding passes for an upcoming flight.

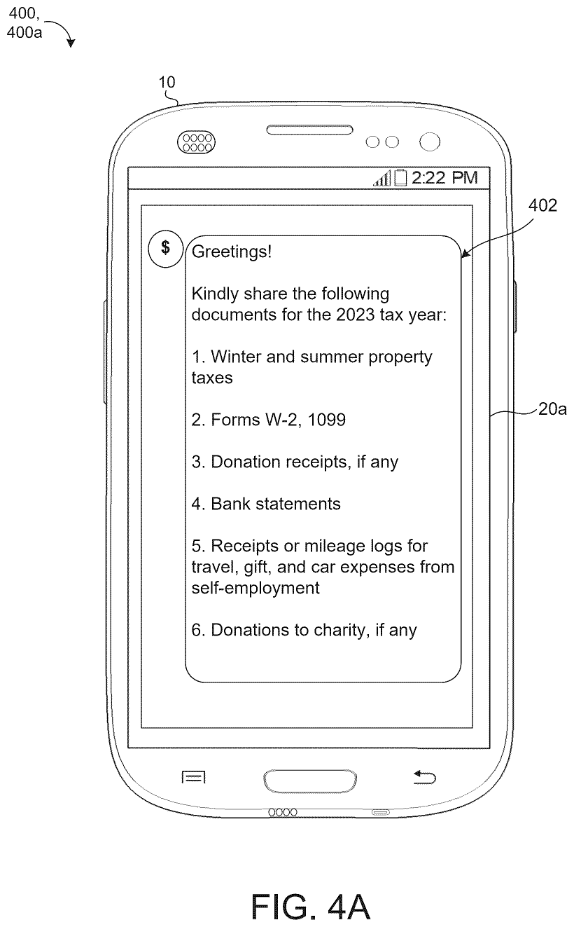

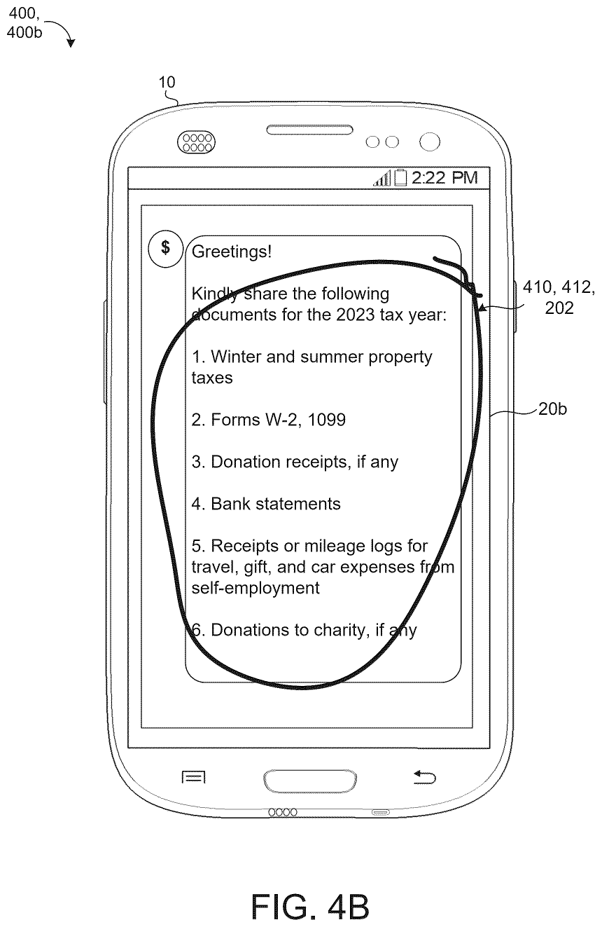

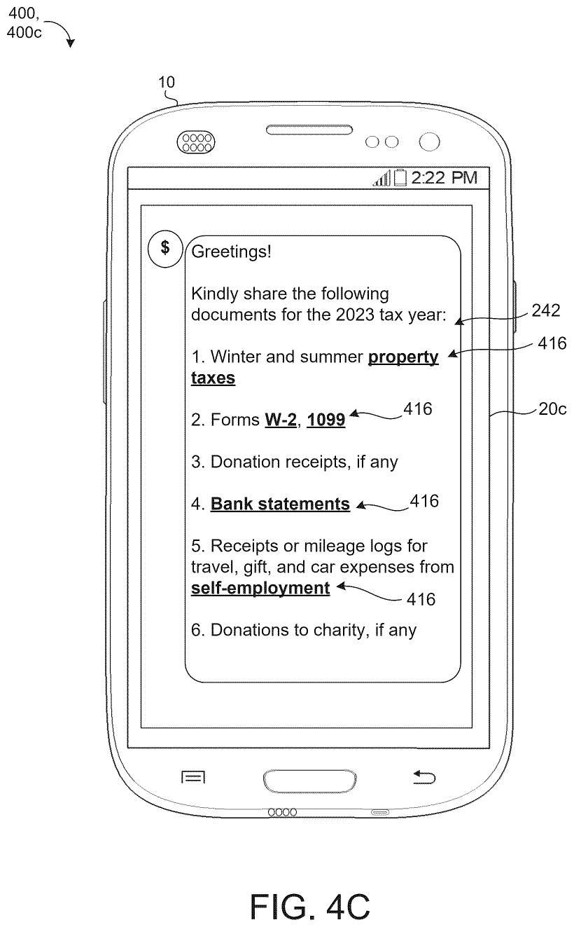

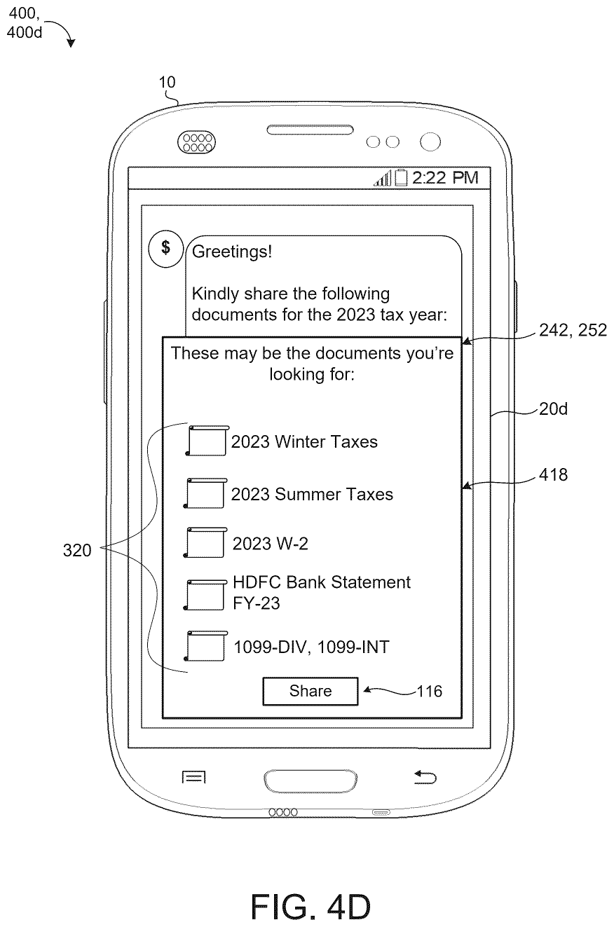

With reference to FIGS. 4A-4D, in some implementations, receiving the query 202 from the user 102 includes receiving a spatial input 410 indicating a lassoing action performed in the GUI 20 at a first location 412. For instance, as shown in FIG. 4A, the GUI 20a displays a message 402 from an accountant of the user 102. In the example shown, the message 402 includes “Greetings! Kindly share the following documents for the 2023 tax year: 1. Winter and summer property taxes, 2. Forms W-2, 1099, 3. Donation receipts, if any, 4. Bank statements, 5. Receipts or mileage logs for travel, gift, and care expenses from self-employment, 6. Donations to charity, if any”. Here, rather than the user 102 manually searching for each individual document 320 needed to help the accountant prepare the 2023 tax return for the user 102, the user 102 invokes the language model system 200 to retrieve the tax documents 320.

Referring to FIG. 4B, to invoke the language model system 200, the user 102 may apply a spatial input 410 of a lassoing action in the GUI 20 of the user device 10. In response to detecting the lassoing action, an NLU module (not shown) of the language model system 200 may crop a subset of image data contained within a region identified by the lassoing action and located at the first location 412 to uniquely identify the object the user 102 is referring to and generate the query 202 for the LLM 240. In the example shown, the object within the region of the lassoing action includes the message 402 from the accountant of the user 102. For instance, the language model system 200 may identify that the lassoing action highlights a sequence of characters displayed in the GUI 20b that refer to 2023 tax documents, and structure the query 202 to direct the LLM 240 to retrieve 2023 tax documents. Thereafter, the embedding identifier 210 may identify a particular embedding chunk 342 of one or more tax documents 320 and the corresponding metadata 322. The prompt structurer 320 may stitch the 2023 tax documents to the query 202 directing the LLM 240 to retrieve the 2023 tax documents to generate the on-the-fly prompt 222. The LLM 240 may then process the on-the-fly prompt 222 by querying, using the on-the-fly prompt 222, the particular embedding chunk 342 to identify which documents 320 in the embedding chunk 342 are relevant to the query 202. For instance, the LLM 240 may identify (e.g., via the metadata 322 of the document 320) which documents 320 are related to the 2023 tax year.

Referring to FIG. 4C, the language model system 200 displays, in the GUI 20c, the personalized response 242 to the query 202. For instance, as shown, the response generator 250 superimposes, in the GUI 20c, graphical indicators 416 highlighting a sequence of characters displayed in the GUI 20a. Here, the LLM 240 may identify that the sequence of characters (e.g., the underlined sequence of characters) correspond to the extracted metadata 322 associated with the one or more 2023 tax documents 320 identified as relevant to the query 202.

Referring to FIG. 4D, the response generator 250 presents the textual representation 252 of the personalized response 242 in the GUI 20d. Here, the user device 10 renders/displays a graphical element 418 representing a notification “these may be the documents you're looking for” to the user 102 of the relevant 2023 tax documents 320 (e.g., “2023 Winter Taxes,” “2023 Summer Taxes,” “2023 W-2,” “HDFC Bank Statement FY-23,” and “1099-DIV, 1099-INT”) retrieved by the LLM 240. The personalized response 242 may include a ranked list of the one or more documents 320 where the list is in order of the most relevant documents 320 to the least relevant documents 320. As shown, the user device 10 renders/displays a graphical element 116 “share” that represents a notification to the user 102 allowing the user 102 to share the identified 2023 tax documents 320 (e.g., with the accountant of the user 102).

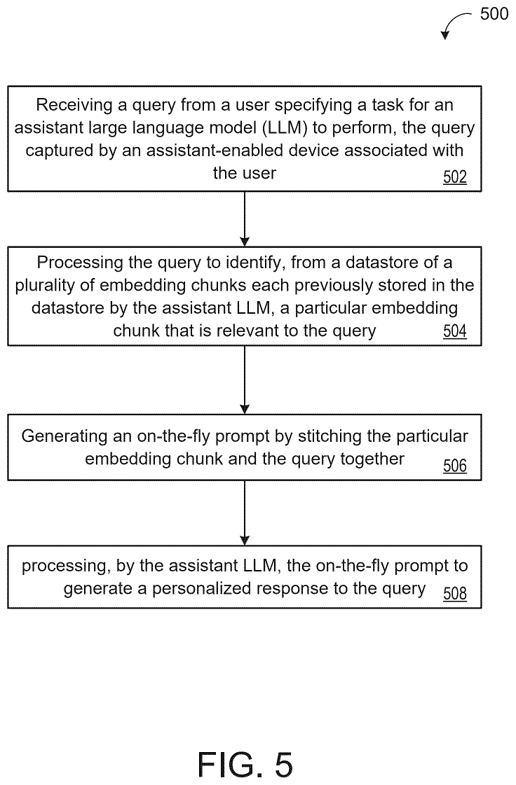

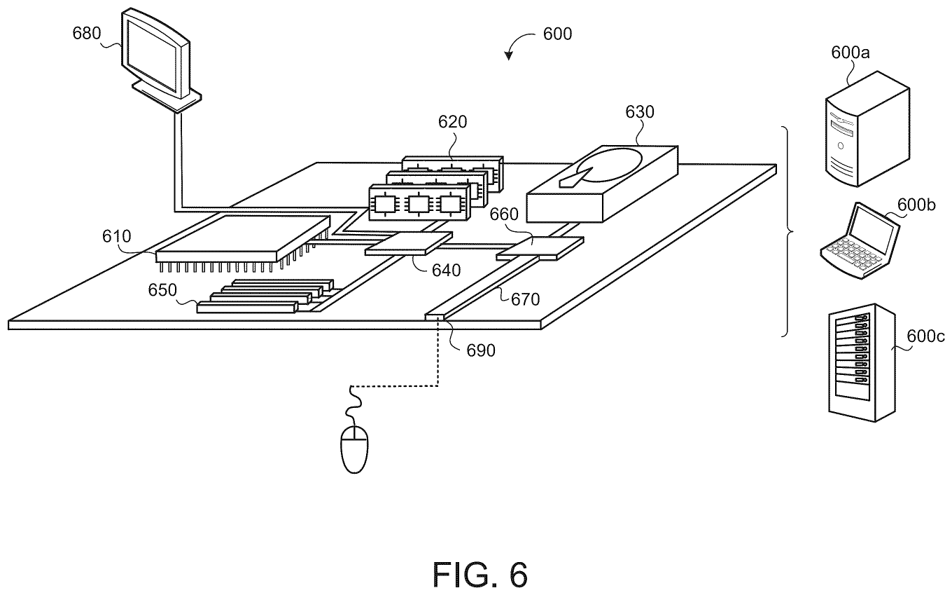

FIG. 5 is a flowchart of an example arrangement of operations for a method 500 of providing personalized responses to prompts using a personalized large language model (LLM). The method 500 may execute on data processing hardware 610 (FIG. 6) (e.g., data processing hardware 12 of the user device 10 and/or data processing hardware 62 of the remote server 60) based on instructions stored on memory hardware 620 (FIG. 6) (e.g., memory hardware 14 of the user device 10 and/or memory hardware 64 of the remote server 60). At operation 502, the method 500 includes receiving a query 202 from a user 102 for an assistant LLM 240 to perform. Here, the query 202 is captured by an assistant-enabled device 10 associated with the user 102.

At operation 504, the method 500 also includes processing the query 202 to identify, from a datastore 230 of a plurality of embedding chunks 342a-n each previously stored in the datastore 230 by the assistant LLM 240, a particular embedding chunk 342 that is relevant to the query 202. The method 500 also includes, at operation 506, generating an on-the-fly prompt 222 by stitching the particular embedding chunk 342 and the query 202 together. At operation 508, the method 500 further includes processing, by the assistant LLM 240, the on-the-fly prompt 222 to generate a personalized response 242 to the query 202.

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 (e.g., the data processing hardware 10, 62 of FIGS. 1A-1C) can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 (e.g., the memory hardware 14, 64 of FIGS. 1A-1C) stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method that when executed on data processing hardware causes the data processing hardware to perform operations comprising:
receiving a query from a user specifying a task for an assistant large language model (LLM) to perform, the query captured by an assistant-enabled device associated with the user;
processing the query to identify, from a datastore of a plurality of embedding chunks each previously stored in the datastore by the assistant LLM, a particular embedding chunk that is relevant to the query;
generating an on-the-fly prompt by stitching the particular embedding chunk and the query together; and
processing, by the assistant LLM, the on-the-fly prompt to generate a personalized response to the query.

2. The computer-implemented method of claim 1, wherein the task specified by the query comprises a retrieval request for the assistant LLM to retrieve one or more documents stored in a personal repository associated with the user.

3. The computer-implemented method of claim 1, wherein the plurality of embedding chunks are stored in the datastore during an indexing process by:
obtaining a plurality of documents stored in a personal repository associated with the user;
assigning each document of the plurality of documents into one or more document chunks;
for each corresponding document chunk of the one or more document chunks, processing the corresponding document chunk to:
extract, from the corresponding document chunk, metadata associated with each of the documents assigned to the corresponding document chunk; and
encode the respective metadata extracted from the corresponding document chunk and the documents assigned to the corresponding document chunk to generate a corresponding embedding chunk; and
storing the embedding chunks in the datastore.

4. The computer-implemented method of claim 3, wherein processing the on-the-fly prompt to generate the personalized response to the query comprises:
querying, using the on-the-fly prompt, the particular embedding chunk stored in the datastore to identify, from the documents assigned to the document chunk associated with the particular embedding chunk, one or more documents relevant to the query; and
summarizing the one or more documents identified as being relevant to the query to generate a summary of relevant documents.

5. The computer-implemented method of claim 4, wherein the operations further comprise displaying, in a graphical user interface (GUI) displayed on a screen in communication with the assistant-enabled device associated with the user, the personalized response to the query.

6. The computer-implemented method of claim 5, wherein displaying the personalized response to the query comprises at least one of:
displaying, in the GUI, a graphical element representing a ranked list of the one or more documents identified as being relevant to the query; or
superimposing, in the GUI, a graphical indicator highlighting a sequence of characters displayed in the GUI at a first location, the sequence of characters corresponding to the extracted metadata associated with the one or more documents identified as being relevant to the query.

7. The computer-implemented method of claim 1, wherein receiving the query from the user comprises one or more of:
receiving audio data corresponding to the query, the audio data spoken by the user and captured by the assistant-enabled device;
receiving, in a graphical user interface (GUI) displayed on a screen in communication with the assistant-enabled device, a user input indication indicating a spatial input applied at a first location in the GUI; or
receiving a textual representation of the prompt.

8. The computer-implemented method of claim 7, wherein the operations further comprise:
detecting a trigger event; and
in response to detecting the trigger event, activating:
the GUI displayed on the screen to enable detection of spatial inputs; and
a speech recognition model to enable the performance of speech recognition on incoming audio data captured by the assistant-enabled device.

9. The computer-implemented method of claim 8, wherein detecting the trigger event comprises one of:
receiving, in the GUI displayed on the screen, a user input indication indicating selection of a graphical element;
receiving a user input indication indicating selection of a physical button disposed on the assistant-enabled device;
detecting a predefined gesture performed by the user; or
detecting a predefined movement/pose of the assistant-enabled device.

10. The computer-implemented method of claim 1, wherein the operations further comprise:
receiving local context associated with the query; and
concatenating the on-the-fly prompt with the local context,
wherein processing the on-the-fly prompt to generate the personalized response to the query comprises processing, by the assistant LLM, the on-the-fly prompt concatenated with the local context to generate the personalized response to the query.

11. A system comprising:
data processing hardware; and
memory hardware in communication with the data processing hardware, the memory hardware storing instructions that when executed on the data processing hardware cause the data processing hardware to perform operations comprising:
receiving a query from a user specifying a task for an assistant large language model (LLM) to perform, the query captured by an assistant-enabled device associated with the user;
processing the query to identify, from a datastore of a plurality of embedding chunks each previously stored in the datastore by the assistant LLM, a particular embedding chunk that is relevant to the query;
generating an on-the-fly prompt by stitching the particular embedding chunk and the query together; and
processing, by the assistant LLM, the on-the-fly prompt to generate a personalized response to the query.

12. The system of claim 11, wherein the task specified by the query comprises a retrieval request for the assistant LLM to retrieve one or more documents stored in a personal repository associated with the user.

13. The system of claim 11, wherein the plurality of embedding chunks are stored in the datastore during an indexing process by:
obtaining a plurality of documents stored in a personal repository associated with the user;
assigning each document of the plurality of documents into one or more document chunks;
for each corresponding document chunk of the one or more document chunks, processing the corresponding document chunk to:
extract, from the corresponding document chunk, metadata associated with each of the documents assigned to the corresponding document chunk; and
encode the respective metadata extracted from the corresponding document chunk and the documents assigned to the corresponding document chunk to generate a corresponding embedding chunk; and
storing the embedding chunks in the datastore.

14. The system of claim 13, wherein processing the on-the-fly prompt to generate the personalized response to the query comprises:
querying, using the on-the-fly prompt, the particular embedding chunk stored in the datastore to identify, from the documents assigned to the document chunk associated with the particular embedding chunk, one or more documents relevant to the query; and
summarizing the one or more documents identified as being relevant to the query to generate a summary of relevant documents.

15. The system of claim 14, wherein the operations further comprise displaying, in a graphical user interface (GUI) displayed on a screen in communication with the assistant-enabled device associated with the user, the personalized response to the query.

16. The system of claim 15, wherein displaying the personalized response to the query comprises at least one of:
displaying, in the GUI, a graphical element representing a ranked list of the one or more documents identified as being relevant to the query; or
superimposing, in the GUI, a graphical indicator highlighting a sequence of characters displayed in the GUI at a first location, the sequence of characters corresponding to the extracted metadata associated with the one or more documents identified as being relevant to the query.

17. The system of claim 11, wherein receiving the query from the user comprises one or more of:
receiving audio data corresponding to the query, the audio data spoken by the user and captured by the assistant-enabled device;
receiving, in a graphical user interface (GUI) displayed on a screen in communication with the assistant-enabled device, a user input indication indicating a spatial input applied at a first location in the GUI; or
receiving a textual representation of the prompt.

18. The system of claim 17, wherein the operations further comprise:
detecting a trigger event; and
in response to detecting the trigger event, activating:
the GUI displayed on the screen to enable detection of spatial inputs; and
a speech recognition model to enable the performance of speech recognition on incoming audio data captured by the assistant-enabled device.

19. The system of claim 18, wherein detecting the trigger event comprises one of:
receiving, in the GUI displayed on the screen, a user input indication indicating selection of a graphical element;
receiving a user input indication indicating selection of a physical button disposed on the assistant-enabled device;
detecting a predefined gesture performed by the user; or
detecting a predefined movement/pose of the assistant-enabled device.

20. The system of claim 11, wherein the operations further comprise:
receiving local context associated with the query; and
concatenating the on-the-fly prompt with the local context,
wherein processing the on-the-fly prompt to generate the personalized response to the query comprises processing, by the assistant LLM, the on-the-fly prompt concatenated with the local context to generate the personalized response to the query.
